(19) United States
(12) Patent Application Publication
(10) Pub. No.: US 2022/0078405 A1
(43) Pub. Date: Mar. 10, 2022

(54) SIMPLIFICATIONS OF CODING MODES BASED ON NEIGHBORING SAMPLES DEPENDENT PARAMETRIC MODELS

(71) Applicant: INTERDIGITAL VC HOLDINGS, INC., Wilmington, DE (US)

(72) Inventors: Edouard FRANCOIS, Bourg des Comptes (FR); Fabrice LELEANNEC, Mouazé (FR); Tangi POIRIER, Thorigné-Fouillard (FR)

(21) Appl. No.: 17/291,164

(22) PCT Filed: Nov. 1, 2019
(86) PCT No.: PCT/US2019/059310

§ 371 Date: May 4, 2021

(30) Foreign Application Priority Data
Nov. 5, 2018 (EP) 18306448.4
Dec. 12, 2018 (EP) 18306676.0
Dec. 13, 2018 (EP) 18306690.1

(51) Int. Cl. H04N 19/105; H04N 19/176; H04N 19/186; H04N 19/159

(52) U.S. Cl. CPC H04N 19/105; H04N 19/159; H04N 19/186; H04N 19/176

(57) ABSTRACT

Aspects aim at improving and simplifying the design of modes similar to CCLM or LIC, that are based on neighboring samples dependent parametric models. Proposed modifications relate to ways of deriving the parameters of the parametric model and designing the parametric-model-based prediction tools contained in a codec in a unified and simplified way. In one embodiment, an approach proposes a simplification of the Cross-component linear model process for deriving the linear parameters. It is proposed to replace the Least Mean Squared method to derive parameters instead as parameters of a straight line passing through two points corresponding to the minimum and maximum luma values among all the luma neighboring reconstructed samples.

### TECHNICAL FIELD

At least one of the present embodiments generally relates to a method or an apparatus for video encoding or decoding, compression or decompression.

### BACKGROUND

To achieve high compression efficiency, image and video coding schemes usually employ prediction, including motion vector prediction, and transform to leverage spatial and temporal redundancy in the video content. Generally, intra or inter prediction is used to exploit the intra or inter frame correlation, then the differences between the original image and the predicted image, often denoted as prediction errors or prediction residuals, are transformed, quantized, and entropy coded. To reconstruct the video, the compressed data are decoded by inverse processes corresponding to the entropy coding, quantization, transform, and prediction.

### SUMMARY

At least one of the present embodiments generally relates to a method or an apparatus for video encoding or decoding, and more particularly, to a method or an apparatus for simplifications of coding modes based on neighboring samples dependent parametric models.

According to a first aspect, there is provided a method. The method comprises steps determining a prediction of a sample in a current block from at least one of neighboring samples in the current block and from a parametric model computed from neighboring samples in the current block and reference samples in a reference frame; and, encoding said sample in the current block based on said prediction.

According to a second aspect, there is provided a method. The method comprises steps for determining a prediction of a sample in a current block from at least one of neighboring samples in the current block and from a parametric model computed from neighboring samples in the current block and reference samples in a reference frame; and, decoding said sample in the current block based on said prediction.

According to another aspect, there is provided an apparatus. The apparatus comprises a processor. The processor can be configured to encode a block of a video or decode a bitstream by executing any of the aforementioned methods.

According to another general aspect of at least one embodiment, there is provided a device comprising an apparatus according to any of the decoding embodiments; and at least one of (i) an antenna configured to receive a signal, the signal including the video block, (ii) a band limiter configured to limit the received signal to a band of frequencies that includes the video block, or (iii) a display configured to display an output representative of a video block.

According to another general aspect of at least one embodiment, there is provided a non-transitory computer readable medium containing data content generated according to any of the described encoding embodiments or variants.

According to another general aspect of at least one embodiment, there is provided a signal comprising video data generated according to any of the described encoding embodiments or variants.

According to another general aspect of at least one embodiment, a bitstream is formatted to include data content generated according to any of the described encoding embodiments or variants.

According to another general aspect of at least one embodiment, there is provided a computer program product comprising instructions which, when the program is executed by a computer, cause the computer to carry out any of the described decoding embodiments or variants.

These and other aspects, features and advantages of the general aspects will become apparent from the following detailed description of exemplary embodiments, which is to be read in connection with the accompanying drawings.

### BRIEF DESCRIPTION OF THE DRAWINGS

FIG. 1 shows example locations of the samples used for the derivation of a and b.

FIG. 2 shows an example of LM_A mode.

FIG. 3 shows an example of LM_L mode.

FIG. 4 shows an illustration of LIC mode in JEM.

FIG. 5 shows a standard, generic video compression scheme

FIG. 6 shows a standard, generic video decompression scheme.

FIG. 7 shows selected samples from top line in most right position and left column in most bottom position.

FIG. 8 shows an example block diagram for using 2 samples in specific positions in the neighborhood.

FIG. 9 shows selected samples from top line in most right position and left column in most bottom.

FIG. 10 shows selected samples from top line in most right and left positions.

FIG. 11 shows selected samples from left column in most top and bottom positions.

FIG. 12 shows selected samples at Bottom-Left, Top-Left and Top-Right positions.

FIG. 13 shows selected samples from top line in most right and left positions.

FIG. 14 shows selected samples from left column in most top and bottom positions.

FIG. 15 shows (a) selected samples at more than three locations, (b) selected samples at two locations top and 2 locations left, and (c) selected samples at three locations top and three locations left.

FIG. 16 shows an example block diagram for testing reliability of linear model derivation.

FIG. 17 shows weights used in mix intra-inter prediction.

FIG. 18 shows one embodiment of a method under the described aspects.

FIG. 19 shows an example processor-based subsystem for implementation of general described aspects.

FIG. 20 shows block diagram of CCLM/MDLM process.

FIG. 21 shows modified block diagram of CCLM/MDLM process according to a first embodiment.

FIG. 22 shows a modified block diagram of CCLM/MDLM process according to a second embodiment.

FIG. 23 shows a modified block diagram of CCLM/MDLM process according to a variant of the second embodiment.

FIG. 24 shows a modified block diagram of CCLM/MDLM process according to a third embodiment.

FIG. 25 shows another embodiment of a method under the described aspects.

FIG. 26 shows an example apparatus under the described aspects.

### DETAILED DESCRIPTION

The embodiments described here are in the field of video compression and generally relate to video compression and video encoding and decoding.

To achieve high compression efficiency, image and video coding schemes usually employ prediction, including motion vector prediction, and transform to leverage spatial and temporal redundancy in the video content. Generally, intra or inter prediction is used to exploit the intra or inter frame correlation, then the differences between the original image and the predicted image, often denoted as prediction errors or prediction residuals, are transformed, quantized, and entropy coded. To reconstruct the video, the compressed data are decoded by inverse processes corresponding to the entropy coding, quantization, transform, and prediction.

In the HEVC (High Efficiency Video Coding, ISO/IEC 23008-2, ITU-T H.265) video compression standard, motion compensated temporal prediction is employed to exploit the redundancy that exists between successive pictures of a video.

To do so, a motion vector is associated to each prediction unit (PU). Each Coding Tree Unit (CTU) is represented by a Coding Tree in the compressed domain. This is a quad-tree division of the CTU, where each leaf is called a Coding Unit (CU).

Each CU is then given some Intra or Inter prediction parameters (Prediction Info). To do so, it is spatially partitioned into one or more Prediction Units (PUs), each PU being assigned some prediction information. The Intra or Inter coding mode is assigned on the CU level.

In the JVET (Joint Video Exploration Team) proposal for a new video compression standard, known as Joint Exploration Model (JEM), it has been proposed to accept a quadtree-binary tree (QTBT) block partitioning structure due to high compression performance. A block in a binary tree (BT) can be split in two equal sized sub-blocks by splitting it either horizontally or vertically in the middle. Consequently, a BT block can have a rectangular shape with unequal width and height unlike the blocks in a QT where the blocks have always square shape with equal height and width. In HEVC, the angular intra prediction directions were defined from 45 degree to −135 degree over a 180 angle, and they have been maintained in JEM, which has made the definition of angular directions independent of the target block shape.

To encode these blocks, Intra Prediction is used to provide an estimated version of the block using previously reconstructed neighbor samples. The difference between the source block and the prediction is then encoded. In the above classical codecs, a single line of reference sample is used at the left and at the top of the current block.

In HEVC (High Efficiency Video Coding, H.265), encoding of a frame of video sequence is based on a quadtree (QT) block partitioning structure. A frame is divided into square coding tree units (CTUs) which all undergo quadtree based splitting to multiple coding units (CUs) based on rate-distortion (RD) criteria. Each CU is either intra-predicted, that is, it is spatially predicted from the causal neighbor CUs, or inter-predicted, that is, it is temporally predicted from reference frames already decoded. In I-slices all CUs are intra-predicted, whereas in P and B slices the CUs can be both intra- or inter-predicted. For intra prediction, HEVC defines 35 prediction modes which includes one planar mode (indexed as mode 0), one DC mode (indexed as mode 1) and 33 angular modes (indexed as modes 2-34). The angular modes are associated with prediction directions ranging from 45 degree to −135 degree in the clockwise direction. Since HEVC supports a quadtree (QT) block partitioning structure, all prediction units (PUs) have square shapes. Hence the definition of the prediction angles from 45 degree to −135 degree is justified from the perspective of a PU (Prediction Unit) shape. For a target prediction unit of size NxN pixels, the top reference array and the left reference array are each of size 2N+1 samples, which is required to cover the aforementioned angle range for all target pixels. Considering that the height and width of a PU are of equal length, the equality of lengths of two reference arrays also makes sense.

The invention is in the field of video compression, more specifically focused on the modes that are using parametric models to perform the prediction of a given block, the parameters of the model being derived from neighboring samples of the block. Two examples of such modes are the “Cross-component linear model” (CCLM) and the “Local illumination compensation” (LIC) modes. The invention aims at simplifying and improving the design of these modes.

### Description of CCLM and Variants

The following section describes different variants of CCLM.

### Basic CCLM Mode Description

In its initial version (cf JVET K1002), CCLM mode consists in predicting the chroma samples based on the reconstructed luma samples of the same block or CU by using a linear model as follows:

pred_{c}(i,j)=a.rec_{L}′(i,j)+b (eq. 1)

where predc(i,j) represents the predicted chroma samples in a CU and rec_{L}′ (i,j) represents the downsampled reconstructed luma samples of the same CU. Parameters a and b are derived by minimizing the regression error between the neighbouring reconstructed luma and chroma samples around the current block as follows:

a=(SLC−SL.SC)/(SLL−SL.SL) (eq. 2)

b=SC−a.SL (eq. 3)

where L(i,j) represents the down-sampled top and left neighbouring reconstructed luma samples, C(i,j) represents the top and left neighbouring reconstructed chroma samples, N is equal to twice of the minimum of width and height of the current chroma coding block, and SL, SC, SLL, SLC are defined a follows (the sign representing the sum over the top and left neighbouring samples):
SL=ΣL(n)
SC=ΣC(n)
SLC=N·Σ(L(n)·C(n))
SLL=N·Σ(L(n)·L(n))

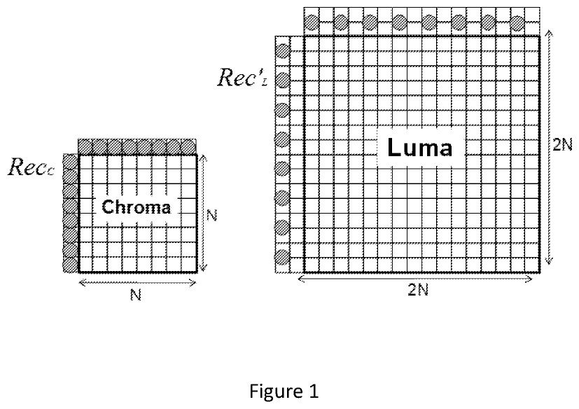

For a coding block with a square shape, the above two equations are applied directly. For a non-square coding block, the neighbouring samples of the longer boundary are first subsampled to have the same number of samples as for the shorter boundary. FIG. 1 shows the location of the left and above samples and the sample of the current block involved in the CCLM mode.

When a CU is coded using CCLM mode, the least mean square (LMS) method is performed in the decoding process. As a result, no syntax is used to convey the a and b values to the decoder.

### MDLM Mde

MDLM mode is an improvement of basic CCLM design proposed in JVET-L0338, where in addition to the (top+left) reference samples template, it is possible to select the left-only or top-only template to derive the the linear model coefficients α and β. This means 2 new CCLM modes, called LM_A, and LM_L, are added.

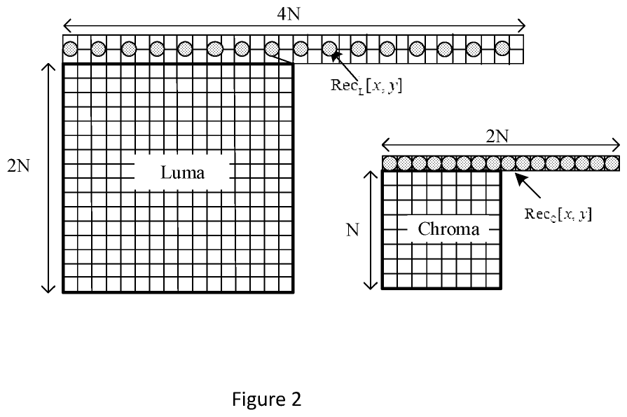

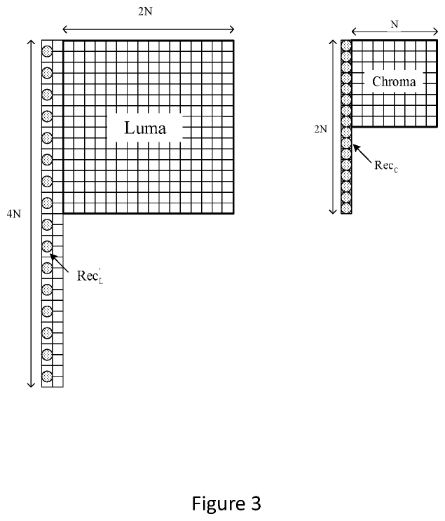

In LM_A mode (see FIG. 2), only the above template is used to calculate the linear model coefficients. To get more samples, the above template is extended to (W+H), where W is a width of a block and H is its height. In LM_L mode (see FIG. 3), only left template is used to calculate the linear model coefficients. To get more samples, the left template is extended to (H+W).

For a non-square block, the above template is extended to W+W, the left template is extended to H+H.

If the above/left template is not available, then the LM_A/LM_L mode will not be checked or signaled. If the number of available samples is not large enough, the template will be padded by copying the right-most (for top template) sample or the below-most (for left template) sample to the nearest log2 number.

CCLM/MDLM with Line Buffer Constraint

In current CCLM coefficients derivation process, 2 luma line buffer are in principle used for down-sampling to get the top template of CCLM mode (CCLM, or MDLM), while only 1 luma line buffer is used in the ordinary luma component intra prediction. To reduce the line buffer, for the CU along with the CTU top boundary, only LM_L mode is used. In this case, no additional line buffer is needed.

### Description of Local Illumination Compensation

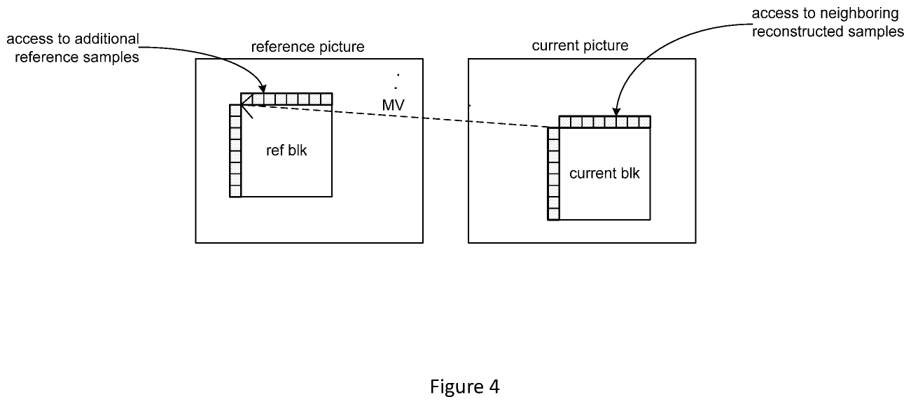

In this tool, the decoder computes some prediction parameters based on some reconstructed picture samples, localized on the left and/or on the top of the current block to be predicted and reference picture samples localized on the left and/or on the top of the motion compensated block (FIG. 4). In the considered prior art codec (JEM), the use of LIC for a given block depends on a flag associated to this block, called the LIC flag.

The LIC parameters (a,b) are based on the least mean square minimization, minimizing the following distortion:

dist=Σ_{r∉Vcur,s∉Vref}(Rcur(r)−a.Rref(s)−b)² (eq. 4)

where Rcur(r) is a neighboring reconstructed sample and Rref(s) is a reference sample. The derivation of a and b is similar to the way a and b are derived in a previous section (eq. 2 and 3).

Once the LIC parameters are obtained by the encoder or the decoder for the current CU, then the prediction pred(i,j) of current CU consists in the following (uni-directional prediction case):

pred(i,j)=a.ref(i,j)+b (eq. 5)

where ref(i,j) is the reference block used for the temporal prediction of the current block.

The general aspects described herein aim at improving and simplifying the design of modes similar to CCLM or LIC, that are based on neighboring samples dependent parametric models. Proposed modifications relate to the way of deriving the parameters of the parametric model and how to design the parametric-model-based prediction tools contained in the codec in a unified and simplified way compared to the prior art.

One approach proposes a simplification of the CCLM process for deriving the linear parameters. It is proposed to replace the LMS method to derive the parameters a and b as parameters of a straight line passing through two points corresponding to the minimum and maximum luma values among all the luma neighbouring reconstructed samples.

a and b values are derived as follows:

a=(C_{B}−C_{A})/(L_{B}−L_{A}) (eq. 6)

b=C_{A}−a.L_{A} (eq. 7)

where (LA,CA) is the couple of luma and chroma values, in the neighbouring reconstructed samples, for which LA has the minimum value among all the luma values, and (LB,CB) is the couple of luma and chroma values, in the neighbouring reconstructed samples, for which LB has the maximum value among all the luma values.

This approach still requires performing multiple checks to identify the minimum and maximum luma values. Also, it may face issues when LA and LA are close.

An LMS approach used in initial CCLM and in LIC schemes has other issues. One important one is that LMS leads to a bias when the input samples are corrupted by noise, which is obviously the case here since the samples are resulting from coding or prediction. This may reduce the coding efficiency of the tool.

The general aspects described herein propose various changes:
Simplification of the selection of the samples used to derive the parameters of the parametric model: samples are fetched from pre-defined locations
using an alternate coding mode when the derivation of the parameters of the parametric model is not reliable
inserting a corrective term in the derivation of the parameters of the parametric model, possibly signaled in the bitstream
unifying the derivation process of parameters of parametric models between LIC and CCLM
extending CCLM for inter blocks and mix intra-inter blocks.

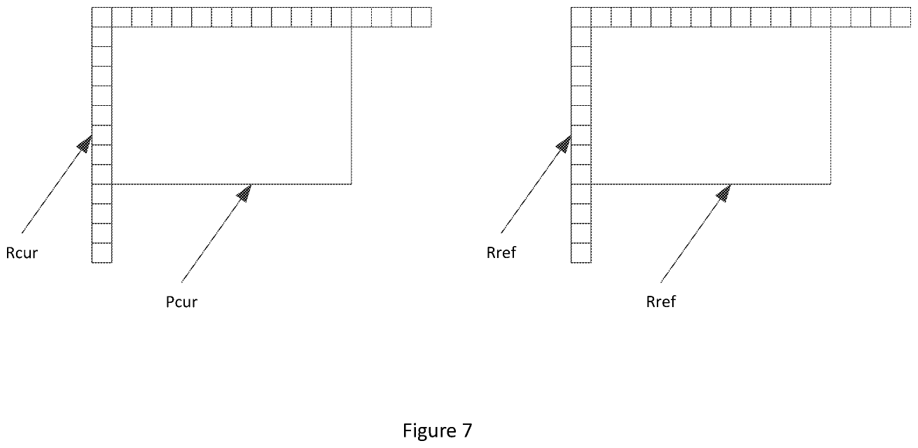

Consider the generic problem of predicting a current block of samples, Pcur(p), at position p in a block of size W columns x H lines, from their collocated reference samples Rref(p). Also consider the samples are represented using a bit-depth of B bits. In CCLM, the reference samples are the reconstructed luma samples. In LIC, the reference samples are the samples from a motion compensated block in a reference picture. Then also consider that in the neighborhood of the block to predict, reconstructed current samples (Rcur) and reconstructed reference samples (Rref) are available. This is illustrated in FIG. 7. Neighboring samples are not necessarily in the closest line/column of the block.

The goal is to derive Pcur(p) for p in the block, from Rref(p) in the block, and from a parametric model computed from samples Rcur and Rref located in the neighborhood of the block (typically upper lines and left columns external to the block).

### Embodiment 1

### Using 2 Samples Directly Selected at Specific Locations in the Reference Samples Array

In one embodiment, in order to simplify the derivation of the parameters of the parametric model, parameters are derived from at least 2 samples of the neighboring samples, selected so as the samples are spatially distant.

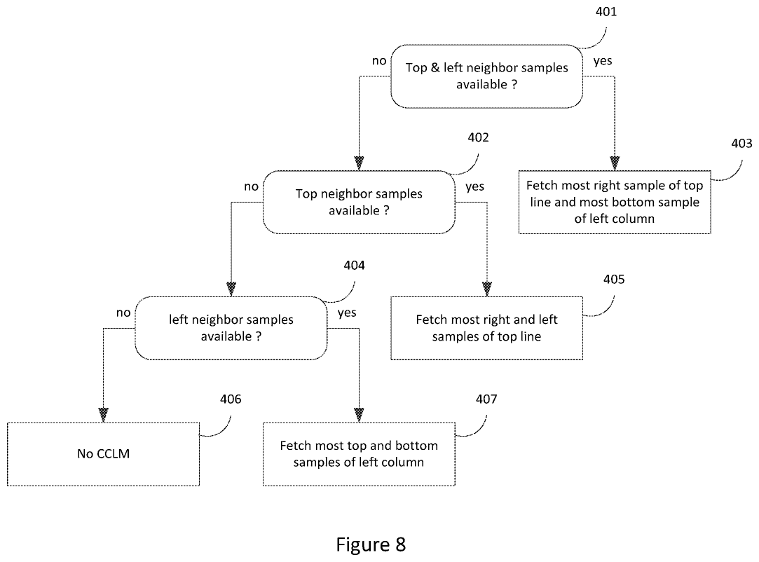

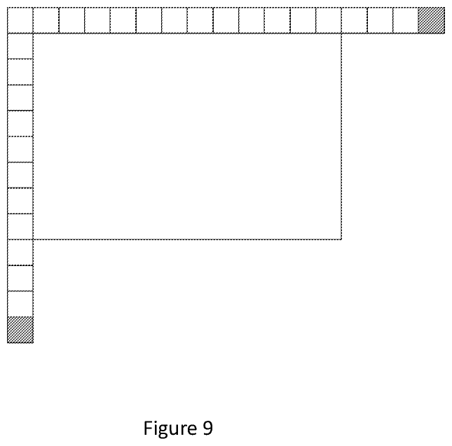

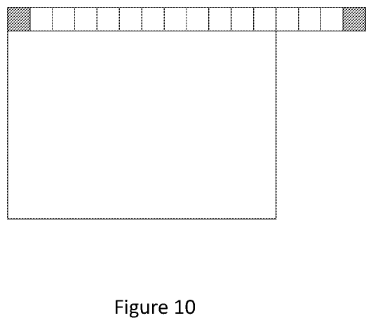

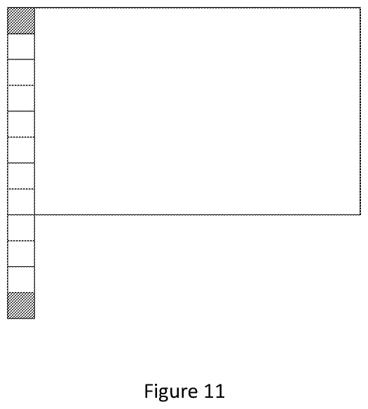

In one implementation, the following process applies (process described in FIG. 8):
If both the top and left samples are available (step 401), the available samples of external top line in the most right position are selected (RrefA,RcurA), and the available samples of external left column in the most bottom position are selected (RrefB,RcurB) (step 403) (see illustration in FIG. 9).
Else If only the top samples are available (step 402), the available samples of external top line in the most right position are selected (RrefA,RcurA), and the available samples of external top line in the most left position are selected (RrefB,RcurB) (step 405) (see illustration of FIG. 10)
Else If only the left samples are available (step 404), the available samples of external left column in the most bottom position are selected (RrefA,RcurA), and the available samples of external left column in the most top position are selected (RrefB,RcurB) (step 407) (see illustration of FIG. 11).
Otherwise, CCLM mode does not apply (step 406).
   Parameters a and b are derived as follows:

a=(Rcur_{B}−Rcur_{A})/(Rref_{B}−Rref_{A}) (eq. 8)

b=Rcur_{A}−a. Rref_{A} (eq. 9)

and the prediction in the block for any location p is computed as:

Pcur(p)=a.Rref(p)+b (eq.10)

Compared to JVET-L0191, the solution avoids multiple checks required to identify the minimum and maximum values of the reference samples in the neighborhood.

The same concept is directly applicable to the MDLM mode. For instance, when top samples are selected to be used in MDLM, then samples as shown in FIG. 10 are used. When left samples are selected to be used in MDLM, then samples as shown in FIG. 11 are used.

### Embodiment 2

### Using 3+ Samples Directly Selected at Specific Locations in the Reference Samples Array

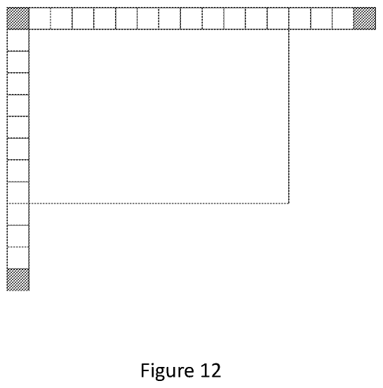

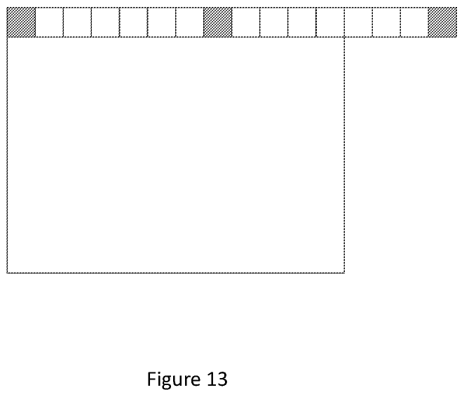

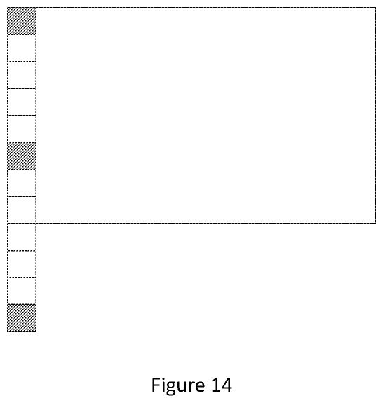

In this embodiment, in order to simplify the derivation of the parameters of the parametric model, parameters are derived from at least 3 samples of the neighboring samples, selected so as the samples are spatially distant as shown in FIG. 12. The concept also applies to MDLM case, as illustrated in FIG. 13 and FIG. 14.

Unlike the approach mentioned earlier, where all samples are compared to find min and max Luma value samples, only 3 or more samples are used to compute min and max Luma values. The worst case is limited to two comparisons in the case of three samples.

Linear model parameters are computed as in that previous approach, following equations 6 and 7.

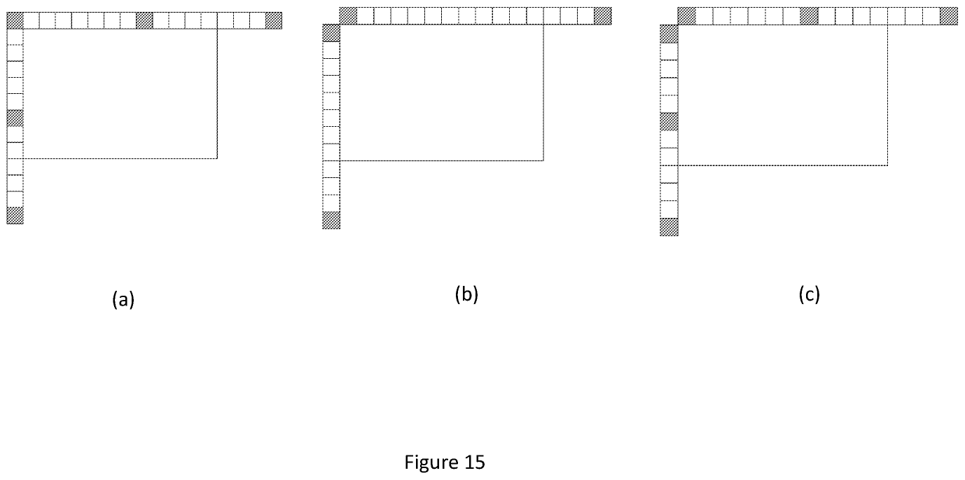

More than three samples may be selected at specific locations as shown in FIG. 15(a).

In another variant, up to 4 samples are used as follows. For the reference samples of top line of size Wtop, samples at positions x=0, x=Wtop−1 are used. For the reference samples of left column of size Hleft, samples at positions y=0, y=Hleft−1 are used. This is illustrated in FIG. 15(b).

In another variant, up to 6 samples are used as follows. For the reference samples of top line of size Wtop, samples at positions x=0, x=Wtop−1 and one sample in the middle (e.g. position x=Wtop/2) are used. For the reference samples of left column of size Hleft, samples at positions y=0, y=Hleft−1 and one sample in the middle (e.g. position y=Hleft/2) are used. This is illustrated in FIG. 15(c).

In an embodiment, in case of computing the linear parameters based on the minimum and maximum values of the reference samples (LA and LB) as in contribution JVET-L0191, these minimum and maximum values are computed only using the selected reference luma samples. As the maximum number of reference samples is reduced in the upper embodiments to 2, 3, 4, 5 or 6, this limits significantly the number of checks needed to identify the minimum and maximum luma samples values. In the contribution JVET-L0191, in the worst case, this number of checks is equal for a given block having Wtop top reference samples and Hleft left reference samples to (Wtop+Hleft)×2. Using the invention, this number is reduced to 2×2, 3×2, 4×2, 5×2 or 6×2.

### Embodiment 3

### Use an Alternate Mode when Linear Model is not Well Defined

The computation of the linear parameters involves a division. In a LMS case, it consists in:

a=(SLC−SL.SC)/(SLL−SL.SL) (eq.11)

In the previous approach, it consists in

a=(Rcur_{B}−Rcur_{A})/(Rref_{B}−Rref_{A}) (eq.12)

In both cases, a is obtained as a=Num/Den, where Num is the numerator, and Den the denominator of the division. This can be problematic when Den is of small amplitude, which may lead to unstable estimation of the linear parameters.

It can also be considered that for blocks of too small size, the number of samples for deriving the linear parameters is not large enough to get a reliable estimation.

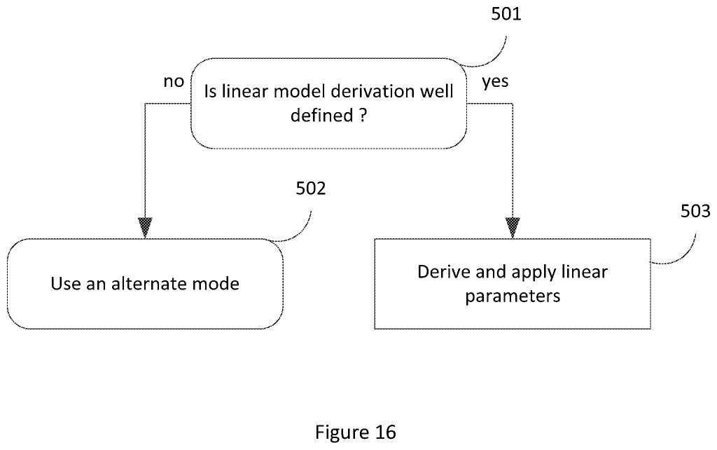

In an embodiment, the linear model-based prediction is used only if the linear parameters derivation is considered as well defined. Otherwise an alternate mode is used (example block diagram in FIG. 16).

Different ways of checking the reliability of the linear parameters derivation can be used. For instance, if one of the following conditions is true, the linear parameters derivation is applied:
If Den>T1,
   Where T1 is a pre-defined threshold that may depend on the block size, and B is the sample bit-depth. For instance
      T1=T2*W*H*2\hat{ }B
      Where T2 is a pre-defined threshold
   If (W×H>Nmin), the linear parameters derivation is applied
   Where W and H are the width and height of the block.

Otherwise, a simplified model is used.

The threshold T1 or T2 can also be signaled at various levels, for example, per SPS, PPS, slice, tile group, tile, CTU, or CU. A specific threshold value can be signaled per block size.

The alternate mode can be based on using a simplified model:
an additive model: a is forced to 1, and only b is derived.

Pcur(p)=Rref(p)+b

a scaling model: b is forced to 0, and only a is derived.

Pcur(p)=a.Rref(p)

### Embodiment 4

### Using a Corrective Parameter in the Derivation of the Linear Parameters

In an embodiment, a corrective parameter CP is introduced in the formula used for deriving the linear parameters.

The advantage of this corrective parameter is an increased coding efficiency compared to the prior art, thanks to the flexibility introduced by multiple possible corrective parameters CP.

CP can be used to correct the numerator or the denominator when deriving the scaling parameter a of the linear model, in an additive or multiplicative mode. The following correction modes can for instance be applied:
Num′=CP *Num and a=Num′/Den
Num′=(Num+CP*sign(Num)) and a=Num′/Den
Den′=CP*Den and a=Num/Den′
Den′=(Den+CP*sign(Den)) and a=Num/Den′

The corrective parameter CP can be signaled at various levels, e.g. per SPS, PPS, slice, tile group, tile, CTU, or CU.

The parameter can be fetched from a limited set of K possible pre-defined values {CP₀, CP₁, . . . CP_{K-1}}. Only an index corresponding to the index of the value in this set can be coded.

CP can be dependent on Num or Den. In particular, when CP is additive, CP can increase with the considered value:
Num′=(Num+(abs(Num)>>K2)*sign(Num)) and a=Num′/Den
Den′=(Den+(abs(Den)>>K2)*sign(Den)) and a=Num/Den′or alternatively, using a negative correction:
Num′=(Num−(abs(Num)>>K2)*sign(Num)) and a=Num′/Den
Den′=(Den−(abs(Den)>>K2)*sign(Den)) and a=Num/Den′

Or alternatively, using a negative correction
Num′=(Num−(abs(Num)>>K2)*sign(Num)) and a=Num′/Den
Den′=(Den−(abs(Den)>>K2)*sign(Den)) and a=Num/Den′

where K2 is a given pre-defined value. For example, K2=6, which is equivalent to CP=k/64. abs(x) is the function returning the module of x.

### Embodiment 4a

### Using a Modified Look-Up-Table for Producing the Division

To ease the implementation, the division, which may add implementation complexity, involved in the derivation of the linear parameters, can be achieved by a look-up-table.

Indeed, the division

a=Num/Den

can be achieved without any division as:

a=(Num*Int((1<<K0)/Den)+offset0)>>K0

where K0 is a given value corresponding to the precision of the division, and offset0 is a given offset value, typically equal to (1<<(K0−1)), and Int( ) is the integer or floor operator (rounding to nearest lower integer value).

More generically, it can be achieved as follows:

a=(Num*(1<<Int(Den/(1<<K1)))*Int((1<<K0)/(Den%K1))+)offset0)>>K0

where K1 is a given parameter fixing the maximum size of the LUT (equal to (1<<K1)), “%” is the modulo operator.

The values Int((1<<K0)/k) can be stored into a look-up-table divLUT[k].

In an embodiment, the look-up-table divLUT[k] is modified to introduce a bias in the estimation, using a corrective parameter CP. The following correction modes can, for example, be applied:

divLUT[k]=Int(2\hat{ }K0/(k+CP)) (eq. 13)

divLUT[k]=Int(2\hat{ }K0/(k*CP)) (eq. 14)

divLUT[k]=Int((2\hat{ }K0+CP)/k) (eq. 15)

divLUT[k]=Int((2\hat{ }K0*CP)/k) (eq. 16)

CP can be dependent on k. In particular, when CP is additive (cases of eq.13 or 15), CP module can increase with k.

In an example,

CP=k>>K2,

or

CP=−k>>K2,

where K2 is a given pre-defined value. For example, K2=6, which is equivalent to CP=k/64 or CP=−k/64.

The LUT can be stored in the decoder. Alternatively, it can be computed on-the-fly, and the corrective parameter CP or K2 can be signaled in the stream at various level, e.g. per SPS, PPS, slice, tile group, tile, CTU, or CU.

### Embodiment 5

### Unifying LIC and CCLM

In a current design of LIC, a LMS process is applied to derive the linear parameters. While in a current CCLM, linear parameters are derived from two set of samples corresponding to the min and max values of the reference luma samples.

In an embodiment, the derivation of the LIC parameters and of the CCLM parameters are unified and use the same simplified process. For instance, the same derivation process based on identifying two sets of samples is used in both tools.

In one embodiment, both LIC and CCLM linear parameters derivation consist in identifying the two sets of samples (RrefA,RcurA), and (RrefB,RcurB) for which RrefA and RrefB correspond to the minimum and maximum values of the neighboring reference samples.

In another embodiment, both LIC and CCLM linear parameters derivation consist in identifying the two set of samples (RrefA,RcurA), and (RrefB,RcurB) fetched at extreme locations in the available neighboring samples locations.

In both cases, the linear parameters are derived as:

a=(Rcur_{B}−Rcur_{A})/(Rref_{B}−Rref_{A}) (eq. 17)

b=Rcur_{A}−a.Rref_{A} (eq. 18)

and the prediction in the block for any location p is computed as:

Pcur(p)=a.Rref(p)+b (eq. 19)

Variants discussed in embodiments 2 and 3 can also apply in both cases.

### Embodiment 6

### Extending CCLM to Inter Blocks

In a current design, CCLM only applies to intra CUs or blocks.

In an embodiment, CCLM is enabled for predicting the chroma component of an inter CU. A new mode, mix inter-CCLM, is therefore introduced herein. The mode can be signaled per CU, using a CU-level flag.
The luma component is coded using an inter mode.
The full process of prediction and reconstruction of the luma component samples is performed.
   The complete reconstruction process is performed, up to the full reconstruction of the luma block samples.
The chroma component samples of the block are predicted using the reconstructed luma samples of the block, using the CCLM mode, that is, using computed linear parameters from the neighboring reconstructed luma and chroma samples of the block.
   This means that the chroma component samples of the block are not built using temporal prediction.

In terms of pipelining of the operations, this new mode raises the same issues as the classical CCLM mode. As reconstructed samples from the neighborhood are required, as well as the reconstructed luma samples from the current block, it is preferable to delay the processing of the blocks coded with the mix inter-CCLM mode once all the intra and inter luma blocks have been processed.

### Embodiment 7

### Extending CCLM to Mix Intra-Inter Blocks

In VTM (Versatilie Video Coding Test Model) a new mode, mix intra-inter, was introduced. The mode combines one intra prediction and one merge indexed temporal prediction. In a merge CU, one flag is signaled for merge mode to select an intra mode from an intra candidate list when the flag is true. For luma components, the intra candidate list is derived from four intra prediction modes including DC, planar, horizontal, and vertical modes, and the size of the intra candidate list can be 3 or 4 depending on the block shape. When the CU width is larger than double the CU height, horizontal mode is exclusive of the intra mode list and when the CU height is larger than double the CU width, vertical mode is removed from the intra mode list. One intra prediction mode selected by the intra mode index and one merge indexed prediction selected by the merge index are combined using a weighted average. For chroma components, DM is always applied without extra signaling.

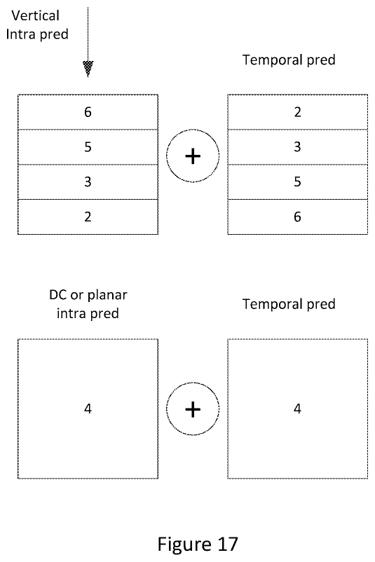

The weights for combining predictions are described as follows (also illustrated in FIG. 17). When DC or planar mode is selected or the block width or height is smaller than 4, equal weights are applied. For those blocks with width and height larger than or equal to 4, when horizontal/vertical mode is selected, one block is first vertically/horizontally split into four equal-area regions. Each weight set, denoted as (w_intra₁, w_inter₁), where i is from 1 to 4 and (w_intra₁, w_inter₁)=(6, 2), (w_intra₂, w_inter₂)=(5, 3), (w_intra₃, w_inter₃)=(3, 5), and (w_intra₄, w_inter₄)=(2, 6), will be applied to a corresponding region. (w_intra₁, w_inter₁) is for the region closest to the reference samples and (w_intra₄, w_inter₄) is for the region farthest away from the reference samples. Then, the combined prediction can be calculated by summing up the two weighted predictions and right-shifting 3 bits. Moreover, the intra prediction mode for the intra hypothesis of predictors can be saved for reference of the following neighboring CUs.

In a proposed embodiment, CCLM is enabled for predicting the chroma component of a mix intra-inter CU. A new mode, mix inter-CCLM, is therefore introduced. The mode can be signaled per CU, using a CU-level flag. The flag indicates if DM or CCLM mode is used.

Alternatively, instead of applying DM mode for chroma, as is done in other approaches, CCLM mode is applied instead of DM.
The luma component is coded using a mix intra-inter mode.
The full process of prediction and reconstruction of the luma component samples is performed.
The chroma component samples of the block are predicted using the reconstructed luma samples of the block, using the CCLM mode, that is, using linear parameters computed from the neighboring reconstructed luma and chroma samples of the block.

In a first version, there is no mix of intra and inter prediction for the chroma component, and the chroma block is completely predicted using the CCLM mode.

In a variant, the weighted mixing of intra and inter prediction, as is done if DM corresponds to the horizontal or vertical modes, is still applied for the chroma component, which means that the final prediction of chroma is a mixing of inter prediction and of CCLM. The mixing process described in the prior-art can be applied.

Alternatively, the same identical weights can be used for the entire chroma blocks, as done in the prior-art in case where DM corresponds to DC and Planar modes.

As in previous embodiments, in terms of pipelining of the operations, it is possible to delay the processing of the blocks coded with the mix inter-CCLM mode once all the intra, inter and mix intra-inter luma blocks have been processed.

### Reduction of the Memory Size Used in CCLM

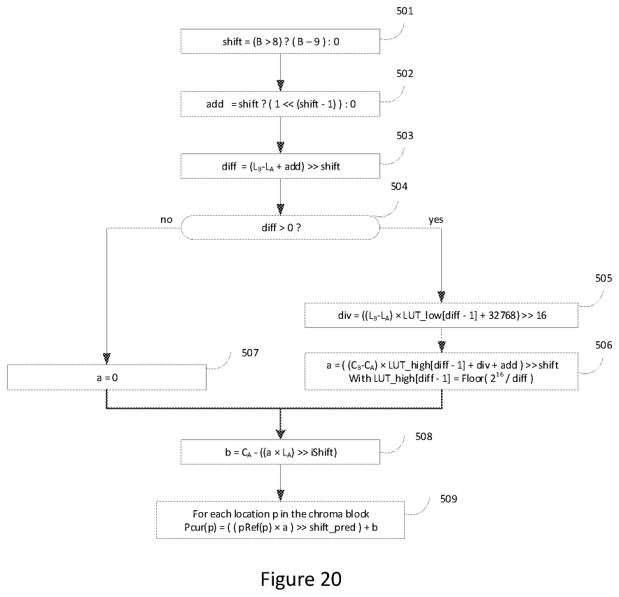

In its practical implementation, the CCLM process in contribution JVET-L0191 is achieved as follows (with B representing the bit-depth of the luma and chroma signals). Once the minimum and maximum luma values LA, LB and their associated chroma values CA, CB have been identified, the linear parameters are derived as follows. The process is illustrated in the block diagram of FIG. 20, using pseudo-code description for each step. The variables a, b, and shift_pred are derived as follows:
Parameters shift, add, diff and k are derived as follows:
   If (B>8), shift is set equal to (B−9), otherwise shift is set equal to 0 (step 501)
   If (shift>0), add is set equal to (1<<(shift−1)), otherwise add is set equal to 0 (step 502)
   diff=(LB−LA+add)>>shift (step 503)
   shift_pred=16
If diff is greater than 0 (step 504), the following applies:
   div=((CB−CA)×LUT_Iow[diff−1]+2¹⁵)>>16 (step 505)
   a=((CB−CA)×LUT_high[diff−1]+div+add)>>shift (step 506)
Otherwise (step 504), the following applies:
   a=0 (step 507)
b is derived as follows (step 508).
   b=CA−(a×LA)>>shift_pred)
      LUT_high and LUT low are 2 look-up-tables of 512 elements each, derived as follows.
         LUT_high[x]=Floor(2¹⁶ /diff)
         LUT_low[x]=Floor(2³²/diff)−Floor(2¹⁶/diff)×2¹⁶
         Floor(x) being the largest integer less than or equal to x
            The prediction samples Pcur(p), for any p in the chroma block, are derived as follows (step 509):
Pcur(p)=((pRef(p)×a)>>shift_pred)+b
   A clipping is also applied to keep the signal inside the allowed range defined by the signal bit-depth.

The following issues are observed:
2 look-up-tables of 512 integers are required, LUT_high and LUT_low
For a signal of more than 8 bits, a right shift of (B−9) is applied to derive the parameter a, which may lead to a loss of accuracy
When generating the prediction samples Pcur(p), the right shift by parameter k is applied to the first term of the formula, which may lead to loss of accuracy
   The following embodiments aim at addressing these issues. They can be combined together.

### Embodiment 8

### Removing of One of the Look-Up-Tables

In one embodiment, the process is simplified by removing the look-up-table LUT low. The parameter a is derived as follows.

a=((C_{B}−C_{A})×LUT_high[diff−1]+add)>>shift

In one variant LUT_high[x] is derived as follows:

LUT_high[x]=Floor((2¹⁶+(diff/2))/diff)

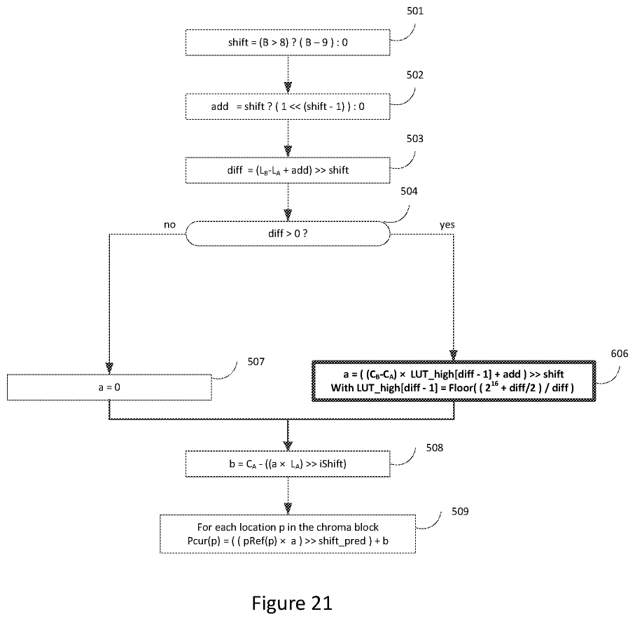

This enables reducing the memory needs by a factor of 2.
The modified process is illustrated in FIG. 21, with changed blocks indicated in bold font. The new block is step 606 that replaces former step 506. Former step 505 is removed.

### Embodiment 9

### Modifying the Access to the Look-Up-Tables

In one embodiment, the access to the look-up-tables is modified as follows.

shift=(L_{B}−L_{A})/2^{K}

or equivalently

shift=(L_{B}−L_{A})>>K

where K is an integer value lower than B.
This enables:
reducing the size of the look-up-tables to 2^{K} elements. When K=8, this limits the tables to 256 elements, instead of 512 in the reference implementation of JVET-L0191.
getting higher accuracy in the computation of a when (LB LA) is lower than 2^{K}, even if 2^{B} is higher than the look-up-tables size. This is not the case in the reference implementation of JVET-L0191 where as soon as 2^{B} is higher than the actual look-up-tables size (512), (L_{B}−L_{A}) is divided by (B−9).

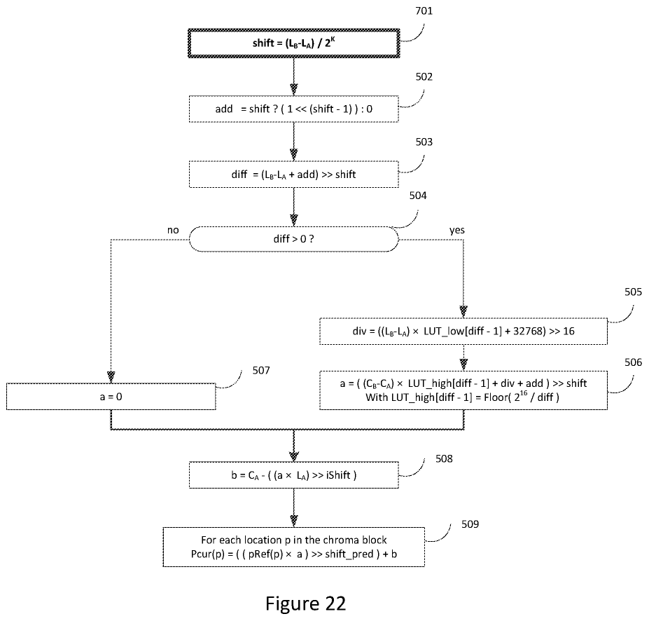

The modified process is illustrated in FIG. 22, with changed blocks indicated in bold font. The new block is step 701 that replaces former step 501.

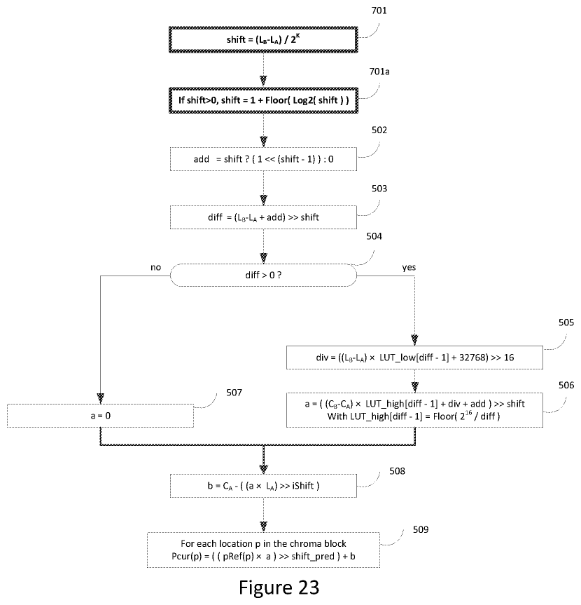

In an embodiment, an additional step 701a is introduced after step 701 and before step 502 to modify the shift value as follows.
If shift>0, shift=1+Floor(Log2(shift))
   where Log2(x) is the base-2 logarithm of x.
   The change is shown in FIG. 23.
   For example, for the case where K=8 (table of size 2^{K}=256 elements), and the input signal bit depth is B=10, the following result is obtained:
If ((L_{B}−L_{A}) is from 0 to 255, shift is set equal to 0
Else If ((L_{B}−L_{A}) is from 256 to 511, shift is set equal to 1
Else If ((L_{B}−L_{A}) is from 512 to 1023, shift is set equal to 2
   This process ensures that the value of (diff−1) remains inside the maximum table index value.

### Embodiment 10

### Adaptation of the Linear Prediction

In one embodiment, to get higher accuracy in the computation of the prediction signal, the parameter b is computed as follows:

b=(C_{A}<<shift_pred)−(a×L_{A})+(1<<(shift_pred−1))

and the linear prediction is performed as follows.

Pcur(p)=(pRef(p)×a+b)>>shift_pred

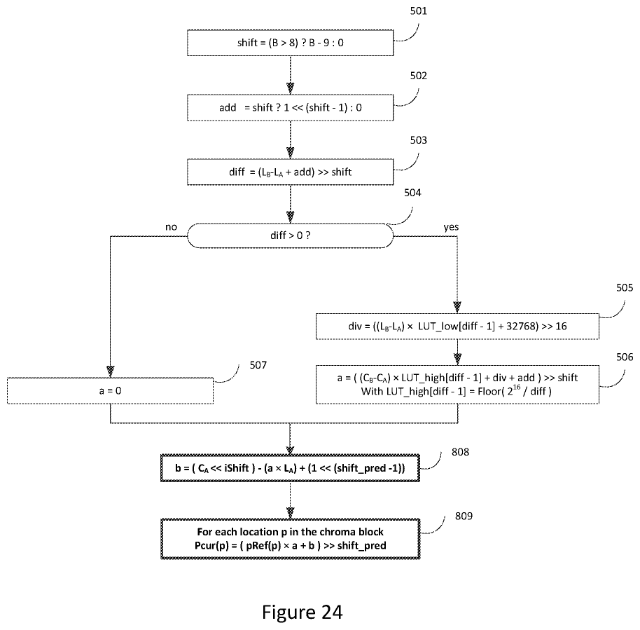

The modified process is illustrated in FIG. 24, with changed blocks indicated in bold font. The new blocks are step 808 that replaces former step 508, and step 809 that replaces former step 509.

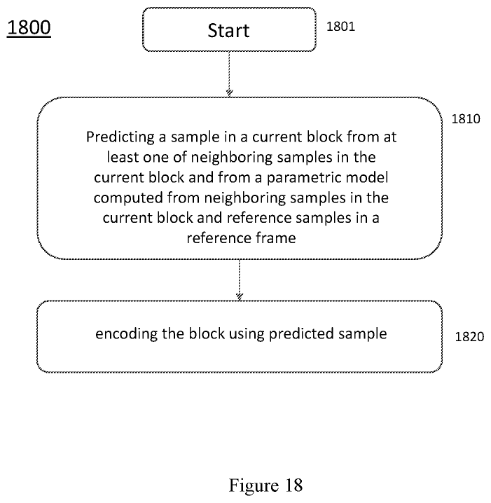

One embodiment of a method 1800 under the general aspects described here is shown in FIG. 18. The method commences at start block 1801 and control proceeds to block 1810 for predicting a sample in a current block from at least one of neighboring samples in the current block and from a parametric model computed from neighboring samples in the current block and reference samples in a reference frame. Control proceeds from block 710 to block 720 for encoding the block using the predicted sample.

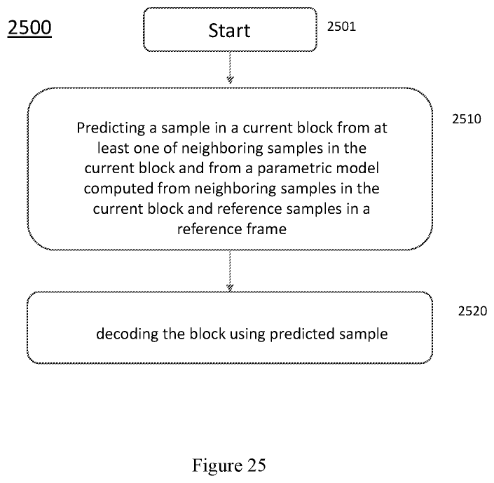

Another embodiment of a method 2500 under the general aspects described here is shown in FIG. 25. The method commences at start block 2501 and control proceeds to block 2510 for predicting a sample in a current block from at least one of neighboring samples in the current block and from a parametric model computed from neighboring samples in the current block and reference samples in a reference frame. Control proceeds from block 2510 to block 2520 for decoding the block using the predicted sample.

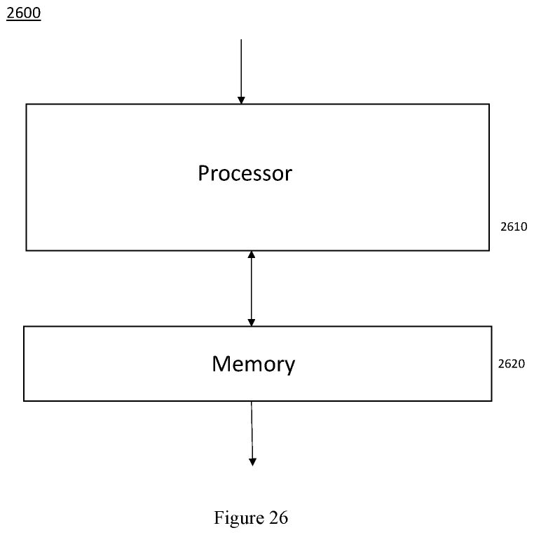

FIG. 26 shows one embodiment of an apparatus 2600 for encoding, decoding, compressing or decompressing video data using simplifications of coding modes based on neighboring samples dependent parametric models. The apparatus comprises Processor 2610 and can be interconnected to a memory 2620 through at least one port. Both Processor 2610 and memory 2620 can also have one or more additional interconnections to external connections.

Processor 2610 is also configured to either insert or receive information in a bitstream and, either compressing, encoding or decoding using any of the described aspects.

This application describes a variety of aspects, including tools, features, embodiments, models, approaches, etc. Many of these aspects are described with specificity and, at least to show the individual characteristics, are often described in a manner that may sound limiting. However, this is for purposes of clarity in description, and does not limit the application or scope of those aspects. Indeed, all of the different aspects can be combined and interchanged to provide further aspects. Moreover, the aspects can be combined and interchanged with aspects described in earlier filings as well.

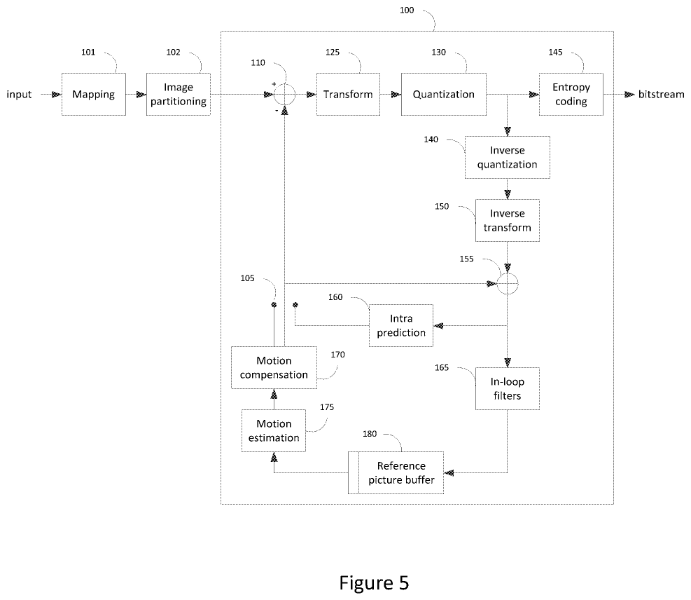

The aspects described and contemplated in this application can be implemented in many different forms. FIGS. 5, 6 and 19 provide some embodiments, but other embodiments are contemplated and the discussion of FIGS. 5, 6 and 19 does not limit the breadth of the implementations. At least one of the aspects generally relates to video encoding and decoding, and at least one other aspect generally relates to transmitting a bitstream generated or encoded. These and other aspects can be implemented as a method, an apparatus, a computer readable storage medium having stored thereon instructions for encoding or decoding video data according to any of the methods described, and/or a computer readable storage medium having stored thereon a bitstream generated according to any of the methods described.

In the present application, the terms “reconstructed” and “decoded” may be used interchangeably, the terms “pixel” and “sample” may be used interchangeably, the terms “image,” “picture” and “frame” may be used interchangeably. Usually, but not necessarily, the term “reconstructed” is used at the encoder side while “decoded” is used at the decoder side.

Various methods are described herein, and each of the methods comprises one or more steps or actions for achieving the described method. Unless a specific order of steps or actions is required for proper operation of the method, the order and/or use of specific steps and/or actions may be modified or combined.

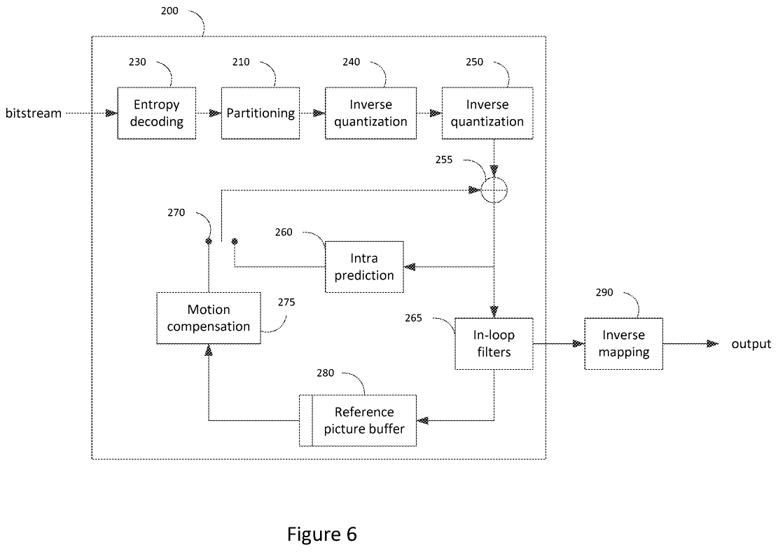

Various methods and other aspects described in this application can be used to modify modules, for example, the intra prediction, entropy coding, and/or decoding modules (160, 360, 145, 330), of a video encoder 100 and decoder 200 as shown in FIG. 5 and FIG. 6. Moreover, the present aspects are not limited to VVC or HEVC, and can be applied, for example, to other standards and recommendations, whether pre-existing or future-developed, and extensions of any such standards and recommendations (including VVC and HEVC). Unless indicated otherwise, or technically precluded, the aspects described in this application can be used individually or in combination.

Various numeric values are used in the present application. The specific values are for example purposes and the aspects described are not limited to these specific values.

FIG. 5 illustrates an encoder 100. Variations of this encoder 100 are contemplated, but the encoder 100 is described below for purposes of clarity without describing all expected variations.

Before being encoded, the video sequence may go through pre-encoding processing (101), for example, applying a color transform to the input color picture (e.g., conversion from RGB 4:4:4 to YCbCr 4:2:0), or performing a remapping of the input picture components in order to get a signal distribution more resilient to compression (for instance using a histogram equalization of one of the color components). Metadata can be associated with the pre-processing and attached to the bitstream.

In the encoder 100, a picture is encoded by the encoder elements as described below. The picture to be encoded is partitioned (102) and processed in units of, for example, CUs. Each unit is encoded using, for example, either an intra or inter mode. When a unit is encoded in an intra mode, it performs intra prediction (160). In an inter mode, motion estimation (175) and compensation (170) are performed. The encoder decides (105) which one of the intra mode or inter mode to use for encoding the unit, and indicates the intra/inter decision by, for example, a prediction mode flag. Prediction residuals are calculated, for example, by subtracting (110) the predicted block from the original image block.

The prediction residuals are then transformed (125) and quantized (130). The quantized transform coefficients, as well as motion vectors and other syntax elements, are entropy coded (145) to output a bitstream. The encoder can skip the transform and apply quantization directly to the non-transformed residual signal. The encoder can bypass both transform and quantization, i.e., the residual is coded directly without the application of the transform or quantization processes.

The encoder decodes an encoded block to provide a reference for further predictions. The quantized transform coefficients are de-quantized (140) and inverse transformed (150) to decode prediction residuals. Combining (155) the decoded prediction residuals and the predicted block, an image block is reconstructed. In-loop filters (165) are applied to the reconstructed picture to perform, for example, deblocking/SAO (Sample Adaptive Offset) filtering to reduce encoding artifacts. The filtered image is stored at a reference picture buffer (180).

FIG. 6 illustrates a block diagram of a video decoder 200. In the decoder 200, a bitstream is decoded by the decoder elements as described below. Video decoder 200 generally performs a decoding pass reciprocal to the encoding pass as described in FIG. 5. The encoder 100 also generally performs video decoding as part of encoding video data.

In particular, the input of the decoder includes a video bitstream, which can be generated by video encoder 100. The bitstream is first entropy decoded (230) to obtain transform coefficients, motion vectors, and other coded information. The picture partition information indicates how the picture is partitioned. The decoder may therefore divide (235) the picture according to the decoded picture partitioning information. The transform coefficients are de-quantized (240) and inverse transformed (250) to decode the prediction residuals. Combining (255) the decoded prediction residuals and the predicted block, an image block is reconstructed. The predicted block can be obtained (270) from intra prediction (260) or motion-compensated prediction (i.e., inter prediction) (275). In-loop filters (265) are applied to the reconstructed image. The filtered image is stored at a reference picture buffer (280).

The decoded picture can further go through post-decoding processing (285), for example, an inverse color transform (e.g. conversion from YCbCr 4:2:0 to RGB 4:4:4) or an inverse remapping performing the inverse of the remapping process performed in the pre-encoding processing (101). The post-decoding processing can use metadata derived in the pre-encoding processing and signaled in the bitstream.

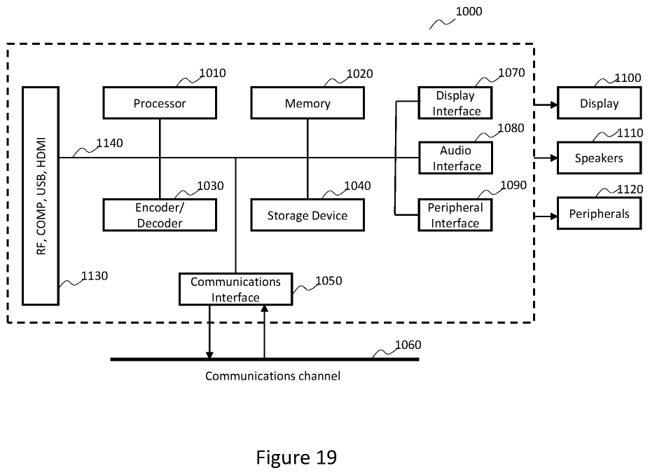

FIG. 19 illustrates a block diagram of an example of a system in which various aspects and embodiments are implemented. System 1000 can be embodied as a device including the various components described below and is configured to perform one or more of the aspects described in this document. Examples of such devices include, but are not limited to, various electronic devices such as personal computers, laptop computers, smartphones, tablet computers, digital multimedia set top boxes, digital television receivers, personal video recording systems, connected home appliances, and servers. Elements of system 1000, singly or in combination, can be embodied in a single integrated circuit (IC), multiple ICs, and/or discrete components. For example, in at least one embodiment, the processing and encoder/decoder elements of system 1000 are distributed across multiple ICs and/or discrete components. In various embodiments, the system 1000 is communicatively coupled to one or more other systems, or other electronic devices, via, for example, a communications bus or through dedicated input and/or output ports. In various embodiments, the system 1000 is configured to implement one or more of the aspects described in this document.

The system 1000 includes at least one processor 1010 configured to execute instructions loaded therein for implementing, for example, the various aspects described in this document. Processor 1010 can include embedded memory, input output interface, and various other circuitries as known in the art. The system 1000 includes at least one memory 1020 (e.g., a volatile memory device, and/or a non-volatile memory device). System 1000 includes a storage device 1040, which can include non-volatile memory and/or volatile memory, including, but not limited to, Electrically Erasable Programmable Read-Only Memory (EEPROM), Read-Only Memory (ROM), Programmable Read-Only Memory (PROM), Random Access Memory (RAM), Dynamic Random Access Memory (DRAM), Static Random Access Memory (SRAM), flash, magnetic disk drive, and/or optical disk drive. The storage device 1040 can include an internal storage device, an attached storage device (including detachable and non-detachable storage devices), and/or a network accessible storage device, as non-limiting examples.

System 1000 includes an encoder/decoder module 1030 configured, for example, to process data to provide an encoded video or decoded video, and the encoder/decoder module 1030 can include its own processor and memory. The encoder/decoder module 1030 represents module(s) that can be included in a device to perform the encoding and/or decoding functions. As is known, a device can include one or both of the encoding and decoding modules. Additionally, encoder/decoder module 1030 can be implemented as a separate element of system 1000 or can be incorporated within processor 1010 as a combination of hardware and software as known to those skilled in the art.

Program code to be loaded onto processor 1010 or encoder/decoder 1030 to perform the various aspects described in this document can be stored in storage device 1040 and subsequently loaded onto memory 1020 for execution by processor 1010. In accordance with various embodiments, one or more of processor 1010, memory 1020, storage device 1040, and encoder/decoder module 1030 can store one or more of various items during the performance of the processes described in this document. Such stored items can include, but are not limited to, the input video, the decoded video or portions of the decoded video, the bitstream, matrices, variables, and intermediate or final results from the processing of equations, formulas, operations, and operational logic.

In some embodiments, memory inside of the processor 1010 and/or the encoder/decoder module 1030 is used to store instructions and to provide working memory for processing that is needed during encoding or decoding. In other embodiments, however, a memory external to the processing device (for example, the processing device can be either the processor 1010 or the encoder/decoder module 1030) is used for one or more of these functions. The external memory can be the memory 1020 and/or the storage device 1040, for example, a dynamic volatile memory and/or a non-volatile flash memory. In several embodiments, an external non-volatile flash memory is used to store the operating system of, for example, a television. In at least one embodiment, a fast external dynamic volatile memory such as a RAM is used as working memory for video coding and decoding operations, such as for MPEG-2 (MPEG refers to the Moving Picture Experts Group, MPEG-2 is also referred to as ISO/IEC 13818, and 13818-1 is also known as H.222, and 13818-2 is also known as H.262), HEVC (HEVC refers to High Efficiency Video Coding, also known as H.265 and MPEG-H Part 2), or VVC (Versatile Video Coding, a new standard being developed by JVET, the Joint Video Experts Team).

The input to the elements of system 1000 can be provided through various input devices as indicated in block 1130. Such input devices include, but are not limited to, (i) a radio frequency (RF) portion that receives an RF signal transmitted, for example, over the air by a broadcaster, (ii) a Component (COMP) input terminal (or a set of COMP input terminals), (iii) a Universal Serial Bus (USB) input terminal, and/or (iv) a High Definition Multimedia Interface (HDMI) input terminal. Other examples, not shown in FIG. 19, include composite video.

In various embodiments, the input devices of block 1130 have associated respective input processing elements as known in the art. For example, the RF portion can be associated with elements suitable for (i) selecting a desired frequency (also referred to as selecting a signal, or band-limiting a signal to a band of frequencies), (ii) downconverting the selected signal, (iii) band-limiting again to a narrower band of frequencies to select (for example) a signal frequency band which can be referred to as a channel in certain embodiments, (iv) demodulating the downconverted and band-limited signal, (v) performing error correction, and (vi) demultiplexing to select the desired stream of data packets. The RF portion of various embodiments includes one or more elements to perform these functions, for example, frequency selectors, signal selectors, band-limiters, channel selectors, filters, downconverters, demodulators, error correctors, and demultiplexers. The RF portion can include a tuner that performs various of these functions, including, for example, downconverting the received signal to a lower frequency (for example, an intermediate frequency or a near-baseband frequency) or to baseband. In one set-top box embodiment, the RF portion and its associated input processing element receives an RF signal transmitted over a wired (for example, cable) medium, and performs frequency selection by filtering, downconverting, and filtering again to a desired frequency band. Various embodiments rearrange the order of the above-described (and other) elements, remove some of these elements, and/or add other elements performing similar or different functions. Adding elements can include inserting elements in between existing elements, such as, for example, inserting amplifiers and an analog-to-digital converter. In various embodiments, the RF portion includes an antenna.

Additionally, the USB and/or HDMI terminals can include respective interface processors for connecting system 1000 to other electronic devices across USB and/or HDMI connections. It is to be understood that various aspects of input processing, for example, Reed-Solomon error correction, can be implemented, for example, within a separate input processing IC or within processor 1010 as necessary. Similarly, aspects of USB or HDMI interface processing can be implemented within separate interface ICs or within processor 1010 as necessary. The demodulated, error corrected, and demultiplexed stream is provided to various processing elements, including, for example, processor 1010, and encoder/decoder 1030 operating in combination with the memory and storage elements to process the datastream as necessary for presentation on an output device.

Various elements of system 1000 can be provided within an integrated housing, Within the integrated housing, the various elements can be interconnected and transmit data therebetween using suitable connection arrangement, for example, an internal bus as known in the art, including the Inter-IC (I2C) bus, wiring, and printed circuit boards.

The system 1000 includes communication interface 1050 that enables communication with other devices via communication channel 1060. The communication interface 1050 can include, but is not limited to, a transceiver configured to transmit and to receive data over communication channel 1060. The communication interface 1050 can include, but is not limited to, a modem or network card and the communication channel 1060 can be implemented, for example, within a wired and/or a wireless medium.

Data is streamed, or otherwise provided, to the system 1000, in various embodiments, using a wireless network such as a Wi-Fi network, for example IEEE 802.11 (IEEE refers to the Institute of Electrical and Electronics Engineers). The Wi-Fi signal of these embodiments is received over the communications channel 1060 and the communications interface 1050 which are adapted for Wi-Fi communications. The communications channel 1060 of these embodiments is typically connected to an access point or router that provides access to external networks including the Internet for allowing streaming applications and other over-the-top communications. Other embodiments provide streamed data to the system 1000 using a set-top box that delivers the data over the HDMI connection of the input block 1130. Still other embodiments provide streamed data to the system 1000 using the RF connection of the input block 1130. As indicated above, various embodiments provide data in a non-streaming manner. Additionally, various embodiments use wireless networks other than Wi-Fi, for example a cellular network or a Bluetooth network.

The system 1000 can provide an output signal to various output devices, including a display 1100, speakers 1110, and other peripheral devices 1120. The display 1100 of various embodiments includes one or more of, for example, a touchscreen display, an organic light-emitting diode (OLED) display, a curved display, and/or a foldable display. The display 1100 can be for a television, a tablet, a laptop, a cell phone (mobile phone), or other device. The display 1100 can also be integrated with other components (for example, as in a smart phone), or separate (for example, an external monitor for a laptop). The other peripheral devices 1120 include, in various examples of embodiments, one or more of a stand-alone digital video disc (or digital versatile disc) (DVR, for both terms), a disk player, a stereo system, and/or a lighting system. Various embodiments use one or more peripheral devices 1120 that provide a function based on the output of the system 1000. For example, a disk player performs the function of playing the output of the system 1000.

In various embodiments, control signals are communicated between the system 1000 and the display 1100, speakers 1110, or other peripheral devices 1120 using signaling such as AV.Link, Consumer Electronics Control (CEC), or other communications protocols that enable device-to-device control with or without user intervention. The output devices can be communicatively coupled to system 1000 via dedicated connections through respective interfaces 1070, 1080, and 1090. Alternatively, the output devices can be connected to system 1000 using the communications channel 1060 via the communications interface 1050. The display 1100 and speakers 1110 can be integrated in a single unit with the other components of system 1000 in an electronic device such as, for example, a television. In various embodiments, the display interface 1070 includes a display driver, such as, for example, a timing controller (T Con) chip.

The display 1100 and speaker 1110 can alternatively be separate from one or more of the other components, for example, if the RF portion of input 1130 is part of a separate set-top box. In various embodiments in which the display 1100 and speakers 1110 are external components, the output signal can be provided via dedicated output connections, including, for example, HDMI ports, USB ports, or COMP outputs.

The embodiments can be carried out by computer software implemented by the processor 1010 or by hardware, or by a combination of hardware and software. As a non-limiting example, the embodiments can be implemented by one or more integrated circuits. The memory 1020 can be of any type appropriate to the technical environment and can be implemented using any appropriate data storage technology, such as optical memory devices, magnetic memory devices, semiconductor-based memory devices, fixed memory, and removable memory, as non-limiting examples. The processor 1010 can be of any type appropriate to the technical environment, and can encompass one or more of microprocessors, general purpose computers, special purpose computers, and processors based on a multi-core architecture, as non-limiting examples.

Various implementations involve decoding. “Decoding”, as used in this application, can encompass all or part of the processes performed, for example, on a received encoded sequence in order to produce a final output suitable for display. In various embodiments, such processes include one or more of the processes typically performed by a decoder, for example, entropy decoding, inverse quantization, inverse transformation, and differential decoding. In various embodiments, such processes also, or alternatively, include processes performed by a decoder of various implementations described in this application.

As further examples, in one embodiment “decoding” refers only to entropy decoding, in another embodiment “decoding” refers only to differential decoding, and in another embodiment “decoding” refers to a combination of entropy decoding and differential decoding. Whether the phrase “decoding process” is intended to refer specifically to a subset of operations or generally to the broader decoding process will be clear based on the context of the specific descriptions and is believed to be well understood by those skilled in the art.

Various implementations involve encoding. In an analogous way to the above discussion about “decoding”, “encoding” as used in this application can encompass all or part of the processes performed, for example, on an input video sequence in order to produce an encoded bitstream. In various embodiments, such processes include one or more of the processes typically performed by an encoder, for example, partitioning, differential encoding, transformation, quantization, and entropy encoding. In various embodiments, such processes also, or alternatively, include processes performed by an encoder of various implementations described in this application.

As further examples, in one embodiment “encoding” refers only to entropy encoding, in another embodiment “encoding” refers only to differential encoding, and in another embodiment “encoding” refers to a combination of differential encoding and entropy encoding. Whether the phrase “encoding process” is intended to refer specifically to a subset of operations or generally to the broader encoding process will be clear based on the context of the specific descriptions and is believed to be well understood by those skilled in the art.

Note that the syntax elements as used herein are descriptive terms. As such, they do not preclude the use of other syntax element names.

When a figure is presented as a flow diagram, it should be understood that it also provides a block diagram of a corresponding apparatus. Similarly, when a figure is presented as a block diagram, it should be understood that it also provides a flow diagram of a corresponding method/process.

Various embodiments refer to parametric models. In particular, during the encoding process, the balance or trade-off between the rate and distortion is usually considered, often given the constraints of computational complexity. It can be measured through a Rate Distortion Optimization (RDO) metric, or through Least Mean Square (LMS), Mean of Absolute Errors (MAE), or other such measurements. Rate distortion optimization is usually formulated as minimizing a rate distortion function, which is a weighted sum of the rate and of the distortion. There are different approaches to solve the rate distortion optimization problem. For example, the approaches may be based on an extensive testing of all encoding options, including all considered modes or coding parameters values, with a complete evaluation of their coding cost and related distortion of the reconstructed signal after coding and decoding. Faster approaches may also be used, to save encoding complexity, in particular with computation of an approximated distortion based on the prediction or the prediction residual signal, not the reconstructed one. Mix of these two approaches can also be used, such as by using an approximated distortion for only some of the possible encoding options, and a complete distortion for other encoding options. Other approaches only evaluate a subset of the possible encoding options. More generally, many approaches employ any of a variety of techniques to perform the optimization, but the optimization is not necessarily a complete evaluation of both the coding cost and related distortion.

The implementations and aspects described herein can be implemented in, for example, a method or a process, an apparatus, a software program, a data stream, or a signal. Even if only discussed in the context of a single form of implementation (for example, discussed only as a method), the implementation of features discussed can also be implemented in other forms (for example, an apparatus or program). An apparatus can be implemented in, for example, appropriate hardware, software, and firmware. The methods can be implemented in, for example, a processor, which refers to processing devices in general, including, for example, a computer, a microprocessor, an integrated circuit, or a programmable logic device. Processors also include communication devices, such as, for example, computers, cell phones, portable/personal digital assistants (“PDAs”), and other devices that facilitate communication of information between end-users.

Reference to “one embodiment” or “an embodiment” or “one implementation” or “an implementation”, as well as other variations thereof, means that a particular feature, structure, characteristic, and so forth described in connection with the embodiment is included in at least one embodiment. Thus, the appearances of the phrase “in one embodiment” or “in an embodiment” or “in one implementation” or “in an implementation”, as well any other variations, appearing in various places throughout this application are not necessarily all referring to the same embodiment.

Additionally, this application may refer to “determining” various pieces of information. Determining the information can include one or more of, for example, estimating the information, calculating the information, predicting the information, or retrieving the information from memory.

Further, this application may refer to “accessing” various pieces of information. Accessing the information can include one or more of, for example, receiving the information, retrieving the information (for example, from memory), storing the information, moving the information, copying the information, calculating the information, determining the information, predicting the information, or estimating the information.

Additionally, this application may refer to “receiving” various pieces of information. Receiving is, as with “accessing”, intended to be a broad term. Receiving the information can include one or more of, for example, accessing the information, or retrieving the information (for example, from memory). Further, “receiving” is typically involved, in one way or another, during operations such as, for example, storing the information, processing the information, transmitting the information, moving the information, copying the information, erasing the information, calculating the information, determining the information, predicting the information, or estimating the information.

It is to be appreciated that the use of any of the following “/”, “and/or”, and “at least one of”, for example, in the cases of “A/B”, “A and/or B” and “at least one of A and B”, is intended to encompass the selection of the first listed option (A) only, or the selection of the second listed option (B) only, or the selection of both options (A and B). As a further example, in the cases of “A, B, and/or C” and “at least one of A, B, and C”, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended, as is clear to one of ordinary skill in this and related arts, for as many items as are listed.

Also, as used herein, the word “signal” refers to, among other things, indicating something to a corresponding decoder. For example, in certain embodiments the encoder signals a particular one of a plurality of coding modes or flags. In this way, in an embodiment the same parameter is used at both the encoder side and the decoder side. Thus, for example, an encoder can transmit (explicit signaling) a particular parameter to the decoder so that the decoder can use the same particular parameter. Conversely, if the decoder already has the particular parameter as well as others, then signaling can be used without transmitting (implicit signaling) to simply allow the decoder to know and select the particular parameter. By avoiding transmission of any actual functions, a bit savings is realized in various embodiments. It is to be appreciated that signaling can be accomplished in a variety of ways. For example, one or more syntax elements, flags, and so forth are used to signal information to a corresponding decoder in various embodiments. While the preceding relates to the verb form of the word “signal”, the word “signal” can also be used herein as a noun.

As will be evident to one of ordinary skill in the art, implementations can produce a variety of signals formatted to carry information that can be, for example, stored or transmitted. The information can include, for example, instructions for performing a method, or data produced by one of the described implementations. For example, a signal can be formatted to carry the bitstream of a described embodiment. Such a signal can be formatted, for example, as an electromagnetic wave (for example, using a radio frequency portion of spectrum) or as a baseband signal. The formatting can include, for example, encoding a data stream and modulating a carrier with the encoded data stream. The information that the signal carries can be, for example, analog or digital information. The signal can be transmitted over a variety of different wired or wireless links, as is known. The signal can be stored on a processor-readable medium.

We describe a number of embodiments. Features of these embodiments can be provided alone or in any combination. Further, embodiments can include one or more of the following features, devices, or aspects, alone or in any combination, across various claim categories and types:
Modifying the coding mode process applied in the decoder and/or encoder.
Enabling several advanced coding mode prediction methods in the decoder and/or encoder.
Inserting in the signaling syntax elements that enable the decoder to identify the coding mode prediction method to use. prediction method to apply at the decoder.
Applying the coding mode prediction method for deriving the mode at the decoder.
Derivation of a parameter with the prediction process above, and with removal of a look-up table.
Derivation of a parameter with the prediction process above, and with modification of a look-up table.
Derivation of prediction parameters using a linear prediction.

Adapting residues at an encoder according to any of the embodiments discussed.
A bitstream or signal that includes one or more of the described syntax elements, or variations thereof.
A bitstream or signal that includes syntax conveying information generated according to any of the embodiments described.
Creating and/or transmitting and/or receiving and/or decoding according to any of the embodiments described.
A method, process, apparatus, medium storing instructions, medium storing data, or signal according to any of the embodiments described.
Inserting in the signaling syntax elements that enable the decoder to determine coding modes in a manner corresponding to that used by an encoder.
Creating and/or transmitting and/or receiving and/or decoding a bitstream or signal that includes one or more of the described syntax elements, or variations thereof.
A TV, set-top box, cell phone, tablet, or other electronic device that performs coding mode determination according to any of the embodiments described.
A TV, set-top box, cell phone, tablet, or other electronic device that performs coding mode determination according to any of the embodiments described, and that displays (e.g. using a monitor, screen, or other type of display) a resulting image.
A TV, set-top box, cell phone, tablet, or other electronic device that selects, bandlimits, or tunes (e.g. using a tuner) a channel to receive a signal including an encoded image, and performs coding mode determination according to any of the embodiments described.
A TV, set-top box, cell phone, tablet, or other electronic device that receives (e.g. using an antenna) a signal over the air that includes an encoded image, and performs coding mode determination.

1. A method, comprising:
determining a prediction of a sample in a current block from at least one of neighboring samples in the current block and from a parametric model computed from neighboring samples in the current block and reference samples in a reference frame;
encoding said sample in the current block based on said prediction.

2. An apparatus, comprising:
a processor, configured to:
determine a prediction of a sample in a current block from at least one of neighboring samples in the current block and from a parametric model computed from neighboring samples in the current block and reference samples in a reference frame;
encode said sample in the current block based on said prediction.

3. A method, comprising:
determining a prediction of a sample in a current block from at least one of neighboring samples in the current block and from a parametric model computed from neighboring samples in the current block and reference samples in a reference frame;
decoding said sample in the current block based on said prediction.

4. An apparatus, comprising:
a processor, configured to:
determine a prediction of a sample in a current block from at least one of neighboring samples in the current block and from a parametric model computed from neighboring samples in the current block and reference samples in a reference frame;
decode said sample in the current block based on said prediction.

5. The method of claim 3, wherein said said parametric model is derived from a linear model.

6. The method of claim 3, wherein said parameters of said parametric model are derived with a lookup table.

7. The method of claim 3, wherein said parameters of said parametric model are derived from at least two samples of neighboring samples that have a spatial distance constraint.

8. The method of claim 3, wherein said parameters of said parametric model are derived from at least three neighboring samples, wherein said three samples are located at rightmost top row of neighboring samples above the block, bottom of left column of neighboring samples, and at an intersection of top reference row and left reference column, respectively.

9. The method of claim 3, wherein a liner model-based prediction is used if linear parameter derivation is well defined, and an alternate mode is used otherwise.

10. The method of 3, wherein a derivation of parameters of said parametric model comprises a corrective parameter.

11. The method of 3, wherein a cross component linear model is enabled for predicting a chroma component of an intercoded block.

12. A device comprising:
an apparatus according to claim 4; and
at least one of (i) an antenna configured to receive a signal, the signal including the video block, (ii) a band limiter configured to limit the received signal to a band of frequencies that includes the video block, and (iii) a display configured to display an output representative of a video block.

13. A non-transitory computer readable medium containing data content generated according to the method of claim 1, for playback using a processor.

14. (canceled)

15. A non-transitory computer-readable medium storing data comprising instructions which, when the program is executed by a computer, cause the computer to carry out the method of claim 1.
